(19) United States
(12) Patent Application Publication
(10) Pub. No.: US 2018/0053338 A1
(43) Pub. Date: Feb. 22, 2018

(54) Method for a user interface

(71) Applicant: Gribbing Oy, Helsinki (FI)

(72) Inventors: Pouira Khademolhosseini, Helsinki (FI); Markus Levlin, Helsinki (FI)

(73) Assignee: Gribbing Oy, Helsinki (FI)

(21) Appl. No.: 15/681,897

(22) Filed: Aug. 21, 2017

(30) Foreign Application Priority Data
Aug. 19, 2016 (FI) 20160207

(51) Int. Cl. G06T 15/20; G06T 19/00; H04N 5/247; H04N 5/232

(52) U.S. Cl. CPC G06T 15/205; G06T 19/006; G06F 3/012; H04N 5/23293; H04N 5/247

(57) ABSTRACT

This invention is related to displaying three-dimensional views and three-dimensional objects on a two-dimensional screen. More specifically, this invention is related to user interfaces of software displaying three-dimensional objects. The invention provides a way for the user to peek around his fingers, which are on top of the user interface or the augmented reality view. This can be implemented, for example, by using the front camera of the smart phone or the tablet to follow where the eyes and/or the face of the user is, and if the user moves his head the view displayed on the screen is changed to provide an illusion of a changed perspective so that the user would see what's beneath his fingers on the screen.

### BACKGROUND OF THE INVENTION

### 1. Field of the Invention

This invention is related to displaying three-dimensional views and three-dimensional objects on a two-dimensional screen. More specifically, this invention is related to user interfaces of software displaying three-dimensional objects.

### 2. Description of Related Art

Currently, augmented reality is under very intensive development and many different solutions for displaying augmented reality views are known. Generally, augmented reality refers to a setup where virtual or calculated objects are shown on top of a view of the real world around the user. This is slightly different compared to virtual reality in which all or substantially all of the view seen by a viewer is virtual.

One area under high development currently is viewing devices for augmented reality and virtual reality. For example, several manufacturers are trying to develop and perfect so-called augmented reality glasses, which allow projection of virtual objects on the normal scene the viewer sees through these augmented reality glasses. One famous example is the HoloLens technology by Microsoft Corporation. Some of these systems use projection of virtual objects towards the viewer's eyes on top of conventional type eyeglasses. Yet another solution provides screens in front of the viewer's eyes so that all of the view of the user is provided through screens. For augmented reality, this kind of setup usually uses cameras to image the real environment ahead of the user.

Another type of environment where augmented reality technology is used is on mobile devices, such as mobile smart phones or tablets where virtual objects are shown on the screen of the smart phone or the tablet on top of a view from the camera of the smart phone or tablet. A recent very famous example of this kind of technology is the currently popular game of Pokemon Go, where virtual Pokemon figures are shown in the real world on top of a view imaged by a video camera of the smart phone or the tablet of the user.

There are certain difficulties in providing good user interfaces for augmented reality type solutions on a small screen, such as on a screen of a smart phone or the screen of a tablet. One of the problems associated with that situation is that the hands and fingers of the user are in the way of the user's view of the screen, blocking the user's view of the augmented reality view or objects in the view, or for example, user interface elements of the user interface. For example, if the user needs to control or touch or act on an object in the augmented reality view on this small screen of his smart phone, one typical way would be just to touch on the image of the object of the screen. However, accurate placement of the touch can be difficult, especially if the object is small or there are many objects nearby each other, because the fingers of the user may cover the object or the nearby objects. This can be a problem, for example, for game applications, 3-D drawing and modeling software, and augmented reality, and virtual reality interfaces in general.

### SUMMARY OF THE INVENTION

The invention aims to solve these problems by providing a way for the user to peek around his fingers, which are on top of the user interface or the augmented reality view. This can be implemented, for example, by using the front camera of the smart phone or the tablet to follow where the eyes and/or the face of the user is, and if the user moves his head the view displayed on the screen is changed to provide an illusion of a changed perspective so that the user would see what's beneath his fingers on the screen.

The device, whether a smart phone or the tablet or another device, images the target environment using its video camera on the back and images the user's face with the video camera on its front. Face and or eye detection allows the device to detect small movements of the user's head and eyes, whereby the device can simulate how the scene and the objects in the scene would be displayed in slightly another perspective as if the device were transparent and the user were just watching the virtual object through a piece of glass. We will describe various embodiments of the invention, to describe different details of the operation of such a user interface in the following with reference to certain figures.

The above summary relates to only one of the many embodiments of the invention disclosed herein and is not intended to limit the scope of the invention, which is set forth in the claims herein. These and other features of the present invention will be described in more detail below in the detailed description of the invention and in conjunction with the following figures.

### BRIEF DESCRIPTION OF THE DRAWINGS

Various embodiments of the invention will be described in detail below, by way of example only, with reference to the accompanying drawings, of which

FIGS. 1A and 1B illustrate functionality provided by an advantageous embodiment of the invention.

### DETAILED DESCRIPTION OF SOME EMBODIMENTS

The following embodiments are exemplary. Although the specification may refer to “an”, “one”, or “some” embodiment(s), this does not necessarily mean that each such reference is to the same embodiment(s), or that the feature only applies to a single embodiment. Single features of different embodiments may be combined to provide further embodiments.

In the following, features of the invention will be described with a simple example of a method in a user interface with which various embodiments of the invention may be implemented. Only elements relevant for illustrating the embodiments are described in detail. Details that are generally known to a person skilled in the art may not be specifically described herein.

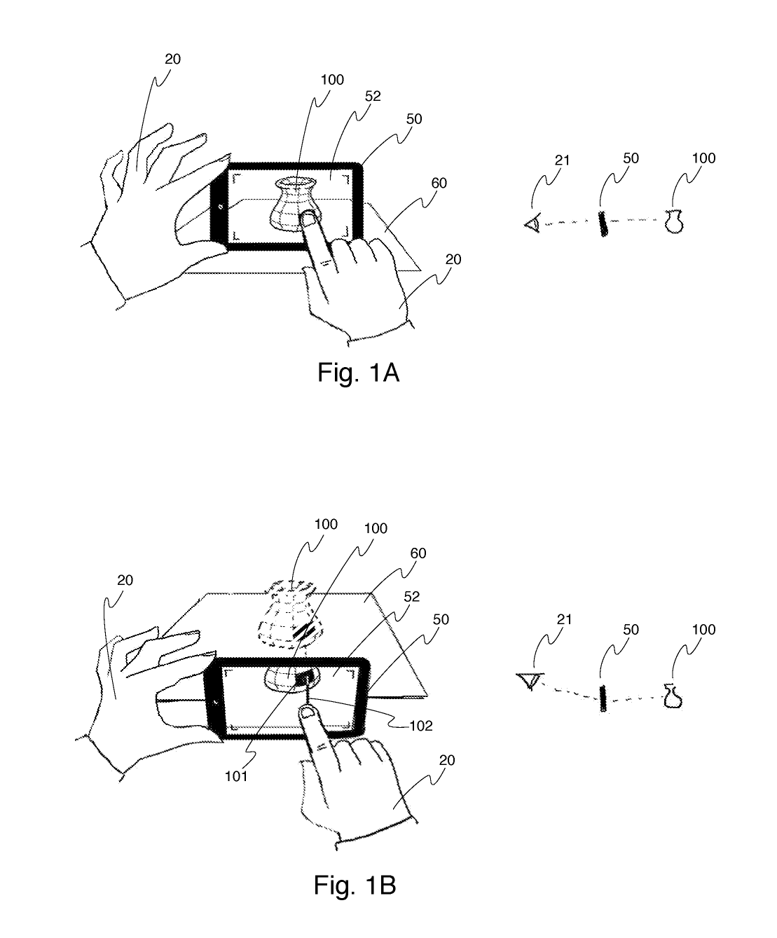

In the following, we will describe the basic operation of an embodiment of the invention with reference to FIG. 1. FIG. 1A shows a mobile device 50, which can be for example a smart phone or a tablet or a similar device. The mobile device 50 has a screen 52, which is showing a virtual object 100 on top of the actual view seen by the back camera of the device 50. The virtual object 100 is shown to be on top of a marker object 60, which can be for example, a sheet of paper such as a sheet of a four paper or a sheet of letter-sized paper. FIG. 1A also illustrates the hands 20 of the user of the device 50.

FIG. 1A illustrates the situation where the virtual object 100, the mobile device 50, and the eyes 21, of the user are along the same line that is the user is viewing straight the object in a straight way. In this setup, when the user wants, for example, to touch a certain location on the virtual object, for example, to change its location or to push the object, the user's finger obscures the exact location the user is touching. However, according to an advantageous embodiment of the invention, the inventive user interface in the mobile device 50 allows the user to peek around his finger. This is illustrated in FIG. 1B. When the mobile device 50 detects that the user moves his head and his eyes slightly so as to peek around his finger, the mobile device changes the view shown on the screen of the mobile device accordingly, shifting it as if seen from a slightly different perspective. That is, the background view is shifted slightly, and the object 100 is also shifted slightly to a little bit different perspective.

As FIG. 1B also illustrates in this situation, the virtual object 100, mobile device 50, and the eyes of the user 21, are not on the same straight line anymore. This allows the user to peek behind his finger using small movements of his head, which is a natural way of looking around fingers. Therefore, a user interface according to this invention is very natural and easy to use.

FIG. 1B also illustrates one possible way of indicating which area of the virtual object 100 a user is touching with his finger. FIG. 1B shows the location 101 on the virtual object 100 as highlighted and with a connecting line 102 from the highlighted position 101 to the end of the user's finger. This is just to present one possible example of showing where the user interface is interpreting the user's finger to point toward.

We also note that FIG. 1B shows the virtual object 100 drawn with dotted lines so as to show the perceived place where the virtual object would be as understood by the user of the mobile device 50 or imagined to be by the user of the mobile device 50.

In an embodiment of the invention, the marker object 60 is used to determine the perspective and the direction of the view the user is looking from in order to display the virtual object 100 in a desired perspective. If the user moves the mobile device further away from the marker object 60, the mobile device can recognize that movement from the video images and therefore change the view shown on the screen 52 accordingly. The marker object 60 can also be another object than a sheet of paper as long as it's something the mobile device, or more accurately, the software providing the user interface can recognize from the video feed of the back camera of the device. For example, the marker object could be a part of the environment, such as the top surface of the table where the user is working on.

In an embodiment of the invention, the software providing the inventive user interface uses face and or eye recognition to recognize where in the video images obtained from the front camera of the mobile device the user's face and or eyes are. Face recognition software are well-known by a man skilled in the art, therefore, the functionality and the properties of face recognition software are not described in any more detail in this specification. However, in addition to the position of the user's eyes and or face, in certain embodiments of the invention, the software can detect at least roughly the distance of the user's face and or eyes from the screen of the mobile device and can use that information to change the view shown on the screen of the mobile device. One exemplary way of determining the distance, or a rough value for the distance, would be to determine the apparent distance between the eyes of the user and determining a relative measure for the distance between the device and the user from that.

In a further embodiment of the invention, the software allows the user to gain different perspectives on the virtual object by allowing the user to move the mobile device around the virtual location of the virtual object and then changing the displayed image of the virtual object in a corresponding way. Naturally, when the user changes the position and or angle of the mobile device, also the apparent direction where the user's face and or eyes are changes as well. In order to provide an easy to use user interface with a natural feeling, a natural way to peek around the user's fingers, in one embodiment of the invention, the view of the object is determined mainly by the location of the mobile device, that is the view provided by the back camera of the device. The relative movement of the user's eyes and or face is taken into account to allow for peeking around the fingers substantially only when the mobile device is held stationary or substantially stationary.

In this embodiment, if the software detects movement in both the back camera view and in the front camera view, the software disregards the changes in the front camera view in order to provide a view of the virtual object and the surroundings that looks and feels natural for the user. According to an advantageous embodiment of the invention, only small movements of the user's face and or eyes are taken into account when showing the peeking around view. In one advantageous embodiment of the invention, this small change in the direction of the user's face and or eyes is a change of less than five degrees. In another embodiment of the invention, the change of direction of the user's face and or eyes is taking into account when the change is less than ten degrees. In an even further advantageous embodiment, the movement of the direction of the face and or eyes of the user is taken into account when the change is less than 20 degrees.

However, in an even further embodiment of the invention, the effect of the observed change in the direction of the user's eyes and or face has soft limits in that when the user moves his head in a certain direction more and more, then the effect of the movement is slowed down gradually until a point where the view doesn't change any more.

In an further embodiment of the invention, when displaying the image, the view seen by the back camera of the device, only a part of that view is shown on the screen of the device so as to provide a possibility for changing the perspective and moving the image of the view on the screen when movement of the user's eyes is detected. This small change in the view allowed by this way of processing the image allows for more realistic looking display of changing of perspective.

In a further embodiment of the invention, change of perspective due to a small movement of the user's face is simulated by moving the rendered image on the screen of the device in a corresponding way as a response to detection of movement of the user's face. Such an embodiment can be realized by showing only a part of the of the video stream view, on which the view of the 3D object is displayed, on the display of the device, whereby change of the view can be implemented by merely shifting the video stream view with the 3D object view on the display of the device in a horizontal and/or vertical direction. Such an embodiment is computationally less intensive than recalculation of the view of the 3D object, and can therefore be beneficial to use in situations where calculation performance of the device is limited.

In the following, we describe certain further embodiments of the invention.

According to a first further group of embodiments of the invention, a method for an user interface for displaying a virtual object on a screen of a device is provided. In an advantageous embodiment of the invention according to this first further group of embodiments of the invention, the method comprises at least the steps of
imaging a first video stream with a first camera of the device,
imaging a second video stream with a second camera of the device,
displaying a view on the screen based on said first video stream,
displaying a virtual object within said view,
determining the position of a viewer's face and/or eyes based on said second video stream, and
if a change in the determined position is detected, changing said displayed view.

According to a further embodiment of this first group of embodiments, changing said displayed view comprises at least the step of displaying a different part of said first video stream on the screen of the device.

According to a further embodiment of this first group of embodiments, changing said displayed view comprises at least the step of displaying said virtual object from a different angle.

According to a second further group of embodiments of the invention, a mobile device performing the above method is provided. According to an embodiment of this second further group of embodiments of the invention, the mobile device is a mobile phone. According to a further embodiment of this second further group of embodiments of the invention, the mobile device is a tablet.

According to a third further group of embodiments of the invention, a software program product embodying the inventive functionality for providing an user interface is provided. According to an embodiment of the invention, the software program product is embodied on a non-transitory storage medium.

In a further embodiment of the invention, the inventive functionality is provided in a non-transitory computer-readable medium having stored thereon computer-readable instructions, wherein executing the instructions by a computing device causes the computing device to perform the inventive functionality described in this specification.

The inventive user interface can be used in many types of software applications such as 3-D modeling and authoring software or, for example, gaming software or other types of augmented or virtual reality software.

In view of the foregoing description it will be evident to a person skilled in the art that various modifications may be made within the scope of the invention. While a preferred embodiment of the invention has been described in detail, it should be apparent that many modifications and variations thereto are possible, all of which fall within the true spirit and scope of the invention.

It is to be understood that the embodiments of the invention disclosed are not limited to the particular structures, process steps, or materials disclosed herein, but are extended to equivalents thereof as would be recognized by those ordinarily skilled in the relevant arts. It should also be understood that terminology employed herein is used for the purpose of describing particular embodiments only and is not intended to be limiting.

Reference throughout this specification to “one embodiment” or “an embodiment” means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. In addition, various embodiments and example of the present invention may be referred to herein along with alternatives for the various components thereof. It is understood that such embodiments, examples, and alternatives are not to be construed as de facto equivalents of one another, but are to be considered as separate and autonomous representations of the present invention.

Furthermore, the described features, structures, or characteristics may be combined in any suitable manner in one or more embodiments. In the following description, numerous specific details are provided, such as examples of lengths, widths, shapes, etc., to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

1. A method for an user interface for displaying a virtual object on a screen of a device, wherein the method comprises at least the steps of
imaging a first video stream with a first camera of the device,
imaging a second video stream with a second camera of the device,
displaying a view on the screen based on said first video stream,
displaying a virtual object within said view,
determining the position of a viewer's face and/or eyes based on said second video stream, and
if a change in the determined position is detected, changing said displayed view.

2. The method according to claim 1, wherein changing said displayed view comprises at least the step of displaying a different part of said first video stream on the screen of the device.

3. The method according to claim 1, wherein changing said displayed view comprises at least the step of displaying said virtual object from a different angle.

4. A mobile device having a screen and at least two cameras wherein the mobile device is arranged to perform a method according to claim 1.

5. The mobile device according to claim 4, wherein the device is a mobile phone.

6. The mobile device according to claim 4, wherein the device is a tablet.

7. A non-transitory computer-readable medium having stored thereon computer-readable instructions for carrying out the method comprising the steps
imaging a first video stream with a first camera of the device,
imaging a second video stream with a second camera of the device,
displaying a view on the screen based on said first video stream,
displaying a virtual object within said view,
determining the position of a viewer's face and/or eyes based on said second video stream, and
if a change in the determined position is detected, changing said displayed view.
